(19) United States
(12) Patent Application Publication
(10) Pub. No.: US 2015/0166878 A1
(43) Pub. Date: Jun. 18, 2015

(54) Mobility Control Fluid Composition Comprising Amine Oxide Compound and Enhanced Oil Recovery Method Using the Same

(71) Applicants: SK Innovation Co., Ltd., Seoul (KR); SK Energy Co., Ltd., Seoul (KR)

(72) Inventors: Jeong Eop Choi, Daejeon (KR); Keon Hyeok Ko, Daejeon (KR); Jong Chan Kim, Daejeon (KR); Han Sol Lee, Daejeon (KR); Young Wook Jeon, Daejeon (KR); Sung Hoon Jung, Daejeon (KR)

(21) Appl. No.: 14/567,905

(22) Filed: Dec. 11, 2014

(30) Foreign Application Priority Data
Dec. 13, 2013 (KR) 10-2013-0155252
Dec. 2, 2014 (KR) 10-2014-0170215

(51) Int. Cl. C09K 8/594; E21B 43/16

(52) U.S. Cl. CPC C09K 8/594; E21B 43/16

(57) ABSTRACT

Provided are a mobility control fluid composition for enhancing oil recovery from an oilfield used for enhancing oil recovery from the oilfield and an enhanced oil recovery method using the same, and more specifically, a mobility control fluid composition including an amine oxide compound and an enhanced oil recovery method from an oilfield using the same. By using the mobility control fluid composition including the amine oxide compound for enhancing oil recovery from the oilfield according to the present invention, foam formation and mobility of the fluid may be effectively controlled.

### CROSS-REFERENCE TO RELATED APPLICATIONS

This application claims priority to Korean Patent Application Nos. 10-2013-0155252 and 10-2014-0170215, filed Dec. 13, 2013 and Dec. 2, 2014, respectively, the disclosures of which are hereby incorporated in their entirety by reference.

### TECHNICAL FIELD

The following disclosure relates to a mobility control fluid composition for enhancing oil recovery from an oilfield used for enhancing oil recovery from the oilfield and an enhanced oil recovery method using the same, and more specifically, to a mobility control fluid composition including an amine oxide compound and an enhanced oil recovery method from an oilfield using the same.

### BACKGROUND

An oil recovery method from an oilfield includes a primary recovery step recovering oil under atmospheric pressure through a well drilled into a well bore and a secondary recovery step recovering oil by injecting water after the primary recovery step to provide driving force where the oil may flow.

However, even though the primary and secondary recovery steps are carried out, significant amounts of oil are still present in the stratum layer of the oilfield; and a method to be adopted for entirely or partially recovering the remaining oil is called enhanced oil recovery (EOR), and, in the case of some of heavy distillate (oil having high viscosity), it is difficult to be recovered without adopting the EOR.

The EOR which is the basis of the present invention is referred to as a tertiary recovery, and the EOR is a method in which the oil trapped in the capillary is extracted by injecting surfactant in order to further enhance oil recovery that remain even after the secondary recovery step, or in which viscosity of water pushing the oil out is increased by injecting a polymer to improve sweep efficiency with respect to the oil, thereby increasing oil recovery.

As the existing oil reserves are rapidly depleted and deteriorated, the growth of chemicals market used for the EOR has been promoted, and in particular, the depletion of the oil reserves becomes serious in U.S. and Europe; however, energy demand is steadily increasing. The oil reserves in these countries have already arrived at puberty, such that oil extraction is becoming more difficult, and a significant amount of oil reserves is not capable of being economically produced but still buried underground, and therefore, the importance of high efficiency EOR is more highlighted.

The EOR has received a lot of attention since oil resources which were difficult to approach in the past are now possible to be swept, and current major oil producers have made continuous effort to find and explore resources buried underground by intensively utilizing an advanced exploration technology and methods in respect to the use of EOR. Regarding this, development of the chemicals for the EOR in order to mine oil through tertiary oil recovery step by injecting the chemicals has also been activated.

In particular, it is known that a gas flooding adopting carbon dioxide as a driving fluid or a CO₂ flooding in the EOR is significantly effective for a field after applying water flooding.

When carbon dioxide is dissolved in the oil to expand volume of the oil, viscosity and interfacial tension of the oil are decreased to allow the remaining oil which is not produced in a reservoir to be easily swept. In addition, the carbon dioxide arrives even at a region into which water is not permeated to thereby allow the oil trapped in the reservoir to be swept.

However, the EOR by the CO₂ flooding has problems in that sweep efficiency is largely deteriorated by fingering and bypassing phenomenon caused by a low viscosity property of the carbon dioxide in a supercritical state when it is injected into the reservoir.

The reason is because the carbon dioxide under the reservoir condition retains a supercritical phase and has density similar to that of the oil, but has viscosity of 0.03 to 0.10 cP, which is low.

In order to overcome the problem, that is, the problem that the sweep efficiency is deteriorated in the EOR using the carbon dioxide, (1) a water-alternating-gas (WAG) decreasing relative permeability of the carbon dioxide by periodically injecting water together with the carbon dioxide, and (2) an indirect method using foam, have been used. However, these methods have a problem in that gas mobility is decreased by gravity segregation or water shielding, and the like, and it is significantly difficult to control foam formation and mobility in the reservoir.

### SUMMARY

An embodiment of the present invention is directed to providing a mobility control fluid composition for more effectively recovering oil by using an amine oxide compound as a mobility control fluid when recovering oil, and an enhanced oil recovery method from an oilfield using the mobility control fluid composition for enhancing oil recovery from the oilfield.

In one general aspect, there is provided a mobility control fluid composition including an amine oxide compound for enhancing oil recovery from an oilfield.

In another general aspect, there is provided an enhanced oil recovery method from an oilfield, including injecting a driving fluid, and injecting a mobility control fluid composition including an amine oxide compound.

### BRIEF DESCRIPTION OF THE DRAWINGS

FIG. 1 shows an apparatus for evaluating foam stability.

FIG. 2 is a view showing a foam produced by Example 1 and a method for measuring foamability of the foam (A: Foam height, B: CO₂ Phase height).

FIG. 3 shows an apparatus for measuring an increase in viscosity due to the foam produced by adding an amine oxide compound.

### DETAILED DESCRIPTION OF MAIN ELEMENTS

11, 21: CO₂ GAS CYLINDER
12, 22, 24: SYRINGE PUMP
13: STIRRIER
14: VIEW CELL
15: CAMERA
16: COMPUTER
23: AMINE OXIDE SOLUTION
25: FOAM GENERATOR
26: CAPILARY TUBE
27: DIFFERENTIAL PRESSURE (dP) MEASURER
28: BACK PRESSURE REGULATOR (BPR)

### DETAILED DESCRIPTION OF EMBODIMENTS

Hereinafter, the present invention will be described in detail.

The present invention is directed to a mobility control fluid composition including an amine oxide compound.

A driving fluid in the mobility control fluid composition for enhancing oil recovery according to the present invention is not limited as long as it is a general material for controlling mobility, but preferably, it may be a fluid which is capable of being in a supercritical state, and more preferably, may be carbon dioxide, which may function as the driving fluid capable of pushing the oil out. The amine oxide compound functioned as the mobility control fluid in the mobility control fluid composition may form a CO₂ in water foam, that is, a foam in which carbon dioxide is formed at an interface of a continuous-phase water, such that viscosity of the carbon dioxide which is the driving fluid may be increased to improve mobility of oil, thereby achieving a process of increasing an oil recovery rate.

Specifically, the amine oxide compound in the mobility control fluid composition is positioned at the interface between water and carbon dioxide to form and retain the foam, and the foam is formed in a CO₂ in water foam in which carbon dioxide is formed at the interface of the continuous-phase water, and is arranged in a structure in which the amine oxide compounds are arranged in the continuous-phase water to prevent phenomenon that a thin film thickness of a foam becomes gradually decreased and finally the foam bursts, which contributes to forming and retaining the foam. The amine oxide compound according to the present invention is not only non-ionic and but also has an ionic property to provide electronic double layer repulsion, which contributes to forming and retaining the foam. In addition, the formation of the stable foam and the retention of the rigid lamella contribute to increasing mobility by increasing viscosity of the mobility control fluid to be 5 to 20 cSt.

A specific example of the amine oxide compound in the composition according to the present invention may include a compound represented by the following Chemical Formula 1, Chemical Formula 2, or mixtures thereof:

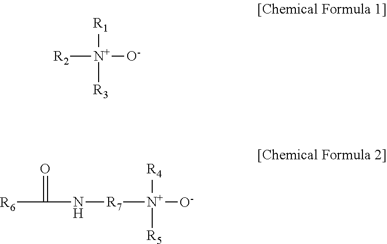

in Chemical Formulas 1 and 2, R₁, R₂, R₃, R₄, R₅ or R₆ is each independently a linear or branched C1-C30 alkyl group, or a C3-C7 cycloalkyl group, R₇ is a C1-C7 alkylene group or a C3-C7 cycloalkylene group, and —CH₂— which is a carbon atom of the alkyl group and the cycloalkyl group of R₁ to R₆ and the alkylene group and the cycloalkylene group of R₇ may be substituted with —NR′— or —O—, and R′ may be hydrogen, or a linear or branched C1-C30 alkyl group.

The alkyl group, the cycloalkyl group, the alkylene group, or the cycloalkylene group of R₁ to R₇ in Chemical Formulas 1 and 2 according to the present invention may be further substituted. with one or more selected. from the group consisting of (C1-C30)alkyl, halo (C1-C30)alkyl, halogen, cyano, (C3-C30)cycloalkyl, (C1-C30)alkoxy, (C6-C30)aryloxy, (C6-C30)aryl, (C6-C30)ar(C1-C30)alkyl, (C1-C30)alkyl(C6-C30)aryl, (C3-C30)heteroarvl, (C1-C30)alkyl-substituted (C3-C30)heteroaryl, (C6-C30)aryl-substituted (C3-C30)heteroarvl, mono or di(C1-C30)alkylamino, mono or di(C6-C30)arylamino, tri(C1-C30)alkylsilyl, diC1-C30)alkyl(C6-C30)arylsilyl, tri(C6-C30)arylsilyl, nitro and hydroxy.

More preferably, in the amine oxide compound represented by Chemical Formula 1 or Chemical Formula 2, R₁ or R₆ may be each independently a linear or branched C7-C30 alkyl group, and R₂, R₃, R₄ or R₅ is each independently a linear or branched C1-C3 alkyl group, and more specifically, the amine oxide compound has the following structure:

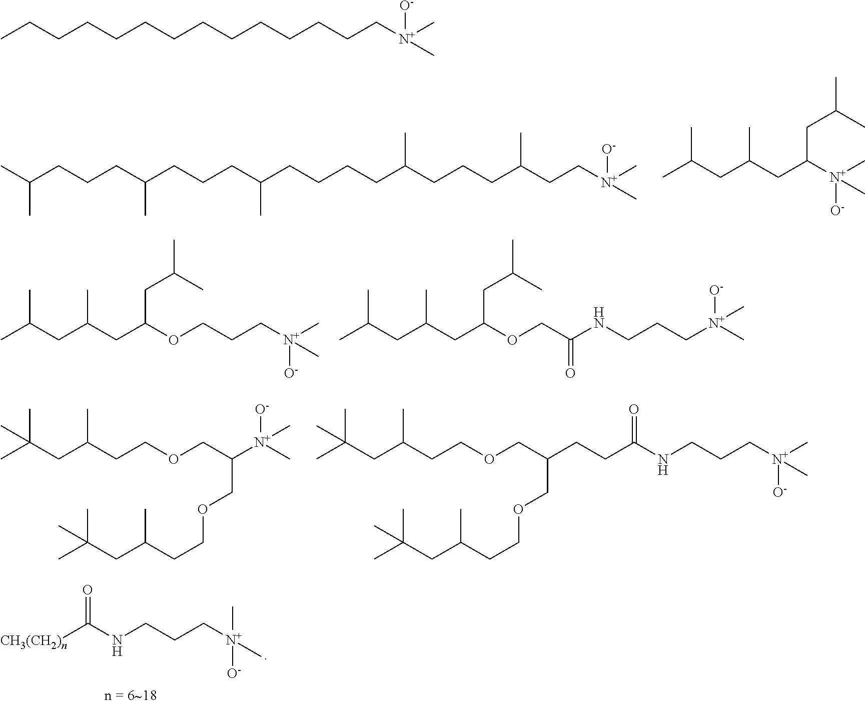

A method for preparing the amine oxide compounds is known in a number of related art documents, and the amine oxide compounds are commercially prepared and sold as purification and personal clothing care usage, which is easily and commercially obtainable.

The amine oxide compound according to the present invention may be included in an amount of 0.01 to 10 wt %, preferably, 0.01 to 8 wt % or 0.01 to 5 wt %, and more preferably, 0.05 to 2 wt %, based on the total composition. In addition, the amine oxide compound is preferably dissolved in water, the driving fluid or mixtures thereof. Here, when the amine oxide compound according to the present invention is used over 10 wt % based on the total composition, viscosity of the composition is increased, workability and diffusion rate are deteriorated, and the amine oxide compound is precipitated, such that it is difficult to implement desired foam stability and to recycle the amine oxide compound. When the amine oxide compound is used below 0.01 wt %, which corresponds to critical micelle concentration (CMC), and therefore, the foam is not formed, which is not desirable.

It is effective for an oilfield to which an enhanced oil recovery method according to the present invention is applied to have a pH of 3 to 10, a temperature of 70° C. or less, and a salt in an amount of 25 % or less.

Further, the present invention provides an enhanced oil recovery method from an oilfield, including injecting a driving fluid, and injecting a mobility control fluid composition including an amine oxide compound. Here, the process of injecting the driving fluid and the process of injecting the mobility control fluid composition including the amine oxide compound may be sequentially performed or may be simultaneously performed.

With the enhanced oil recovery method from an oilfield according to an exemplary embodiment of the present invention, carbon dioxide as the driving fluid may be injected into the oilfield through an injection well and the mobility control fluid composition including the amine oxide compound may be injected through the driving fluid injection well or another injection well.

It is preferable that the process of injecting the driving fluid and the mobility control fluid composition is stopped when the driving fluid is swept into a producing well bore, and the mobility control fluid composition including the amine oxide compound and the driving fluid may be injected as a mixture or may be alternately injected. Preferable example of the driving fluid may be carbon dioxide.

In the enhanced oil recovery method from an oilfield according to an exemplary embodiment of the present invention, the amine oxide compound included in the mobility control fluid composition may be represented by the following Chemical Formula 1 or the following Chemical Formula 2, or may be mixtures thereof:

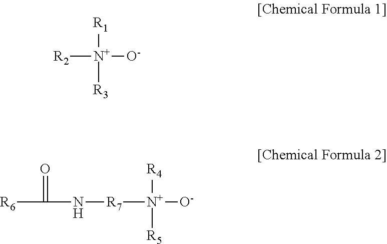

in Chemical Formulas 1 and 2, R₁, R₂, R₃, R₄, R₅ or R₆ is each independently a linear or branched C1-C30 alkyl group, or a C3-C7 cycloalkyl group, R₇ is a C1-C7 alkylene group or a C3-C7 cycloalkylene group, and —CH₂— which is a carbon atom of the alkyl group and the cycloalkyl group of R₁ to R₆ and the alkylene group and the cycloalkylene group of R₇ may be substituted with —NR′— or —O—, and R′ may be hydrogen, or a linear or branched C1-C30 alkyl group.

The amine oxide compound included in the mobility control fluid composition according to an exemplary embodiment of the present invention may be preferably selected from the following structural compounds, but the present invention is not limited thereto:

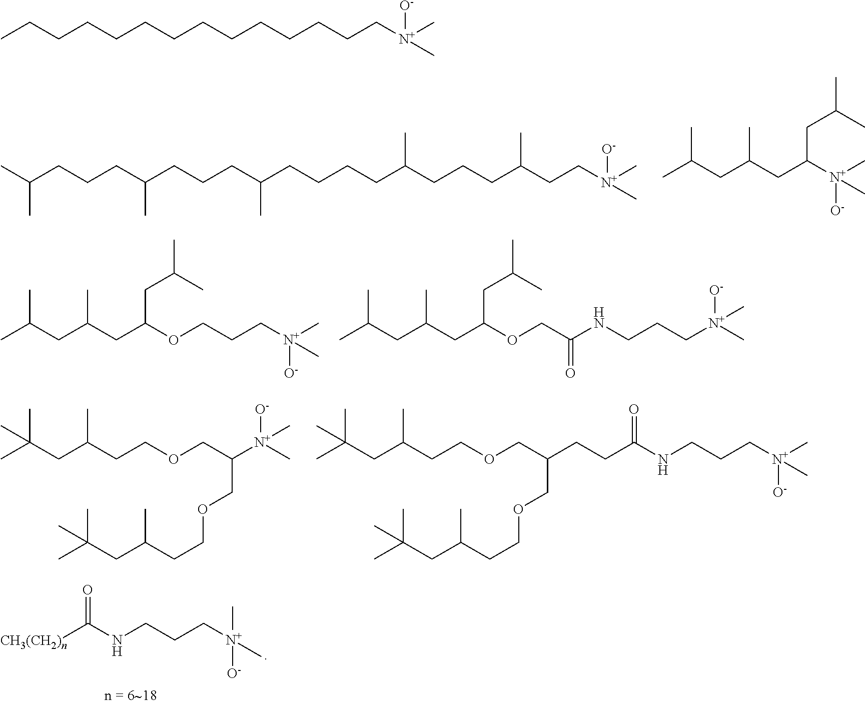

In addition, in the enhanced oil recovery method from an oilfield according to an exemplary embodiment of the present invention, when the above-described amine oxide compound included in the mobility control fluid composition is the following compounds having a linear structure, the following structurally linear compound provides stronger electronic double layer repulsion and contributes to achieving foam stability, thereby forming and retaining rigid lamella:

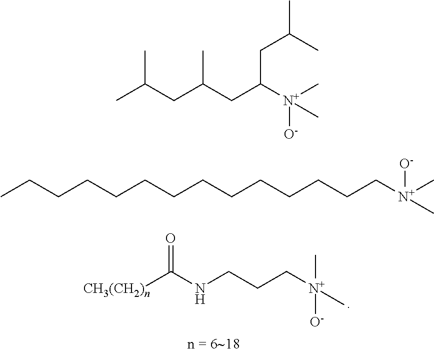

Hereinabove, although the present invention is described based on exemplary embodiments, they are provided only for assisting the overall understanding of the present invention. Therefore, the present invention is not limited to the exemplary embodiments. Various modifications and changes may be made by those skilled in the art to which the present invention pertains from this description.

### EXAMPLE 1

### Evaluation on Foam Stability

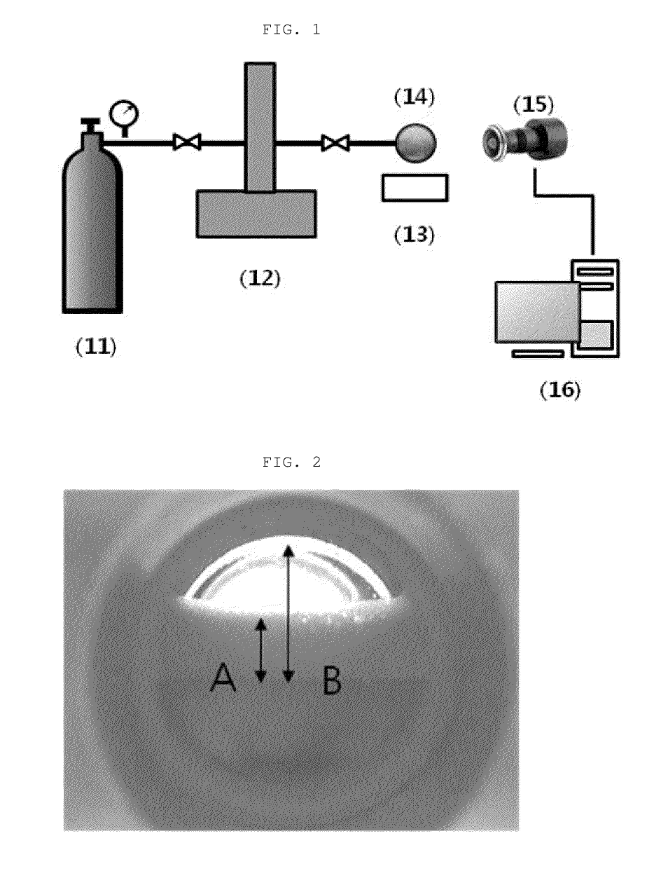

Foam stability was evaluated according to constitution shown in FIG. 1. 8 ml volumetric flask was filled with 4 ml of sea water or brine water and 1 wt % of myristyl dimethyl amine oxide represented by the following structure as an amine oxide compound was injected thereinto, and carbon dioxide was added so as to satisfy conditions of 140 bar at 40° C. and 50° C., followed by stirring for 10 minutes. After stirring was stopped, foamability [(foam height/CO₂ phase height)×100] of the produced foam was measured each time in order to confirm foam stability as shown in FIG. 2, and result of the measurement was shown in Table 1.

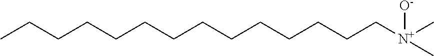 [SMILES: CCCCCCCCCCCCCC[N+](C)(C)[O-]]

Myristyl dimethyl amine oxide

TABLE 1

| | | | Foamability (%) | | | | |
|---|---|---|---|---|---|---|---|
| Temperature | Pressure | | | | | | 120 |
| (° C. ) | (bar) | Salinity | 0 min | 5 min | 10 min | 60 min | min |
| 40 | 140 | Brine* | 100 | 71 | 71 | 71 | 71 |
| 40 | 140 | Hard | 100 | 70 | 68 | 68 | 68 |
| | | Brine** | | | | | |
| 50 | 140 | Hard | 100 | 64 | 64 | 64 | 64 |
| | | Brine | | | | | |

*Brine: NaCl 2%, CaCl₂ 1%, MgCl₂ 0.5%,
**Hard Brine: NaCl 12%, CaCl₂ 0.5%, MgCl₂ 0.01%

### EXAMPLE 2

### Evaluation on Foam Stability

The same process as Example 1 was conducted except for injecting 1 wt % of cocamido propyl dimethyl amine oxide as the amine oxide compound, then foam stability was measured each time, and result of the measurement was shown in Table 2.

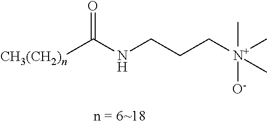

Cocamido propyl dimethyl amine oxide

TABLE 2

| | | | Foamability (%) | | | | |
|---|---|---|---|---|---|---|---|
| Temperature | Pressure | | | | | | 120 |
| (° C. ) | (bar) | Salinity | 0 min | 5 min | 10 min | 60 min | min |
| 40 | 140 | Brine | 100 | 67 | 67 | 67 | 67 |
| 40 | 140 | Hard | 100 | 59 | 59 | 59 | 56 |
| | | Brine | | | | | |

### EXAMPLE 3

### Evaluation of Increase in Viscosity by Foam

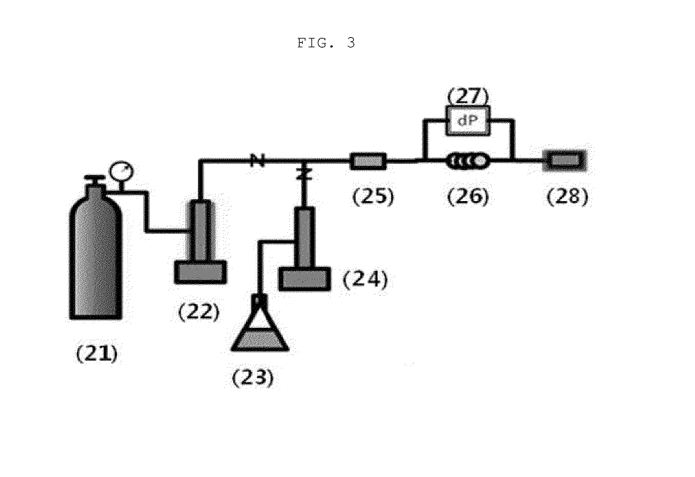

An increase in viscosity by the produced foam was measured by adding 0.5 wt % of an amine oxide compound and using an apparatus shown in FIG. 3. Carbon dioxide and water were injected at a volume ratio of 4 volume of carbon dioxide to 1 volume of brine (4:1volumetric ratio based on carbon dioxide and water in a liquid state). The viscosity was calculated by measuring differential pressure at both sides of coiled capillary, and result of the measurement was shown in Table 3.

TABLE 3

| Amine Oxide | Temperature | Pressure | | Viscosity |
|---|---|---|---|---|
| Compound | (° C.) | (bar) | Salinity | (cP) |
| Myristyl dimethyl | 40 | 140 | Hard Brine | 43 |
| amine oxide | | | | |
| Cocamido propyl | 40 | 140 | Hard Brine | 28 |
| dimethyl amine oxide | | | | |
| Branched alkyl amine | 40 | 140 | Hard Brine | 18 |
| oxide | | | | |

As appreciated in the result shown in Examples above, it was confirmed that by using the amine oxide compound, stable foam could be formed and the increase in viscosity by the foam formation was shown as 20 cP or more, such that the composition of the present invention could be sufficiently applied as the mobility control fluid.

When the mobility control fluid composition including the amine oxide compound according to the present invention is applied to a carbon dioxide—enhanced oil recovery method using carbon dioxide as a driving fluid, the amine oxide compound is included in the carbon dioxide, such that foam formation and mobility of the fluid may be effectively controlled. In addition, the foam formation and mobility of the fluid may be controlled to solve a problem of the existing method in that sweep efficiency is deteriorated by fingering and bypassing phenomenon caused by a low viscosity property of the carbon dioxide in a supercritical state, and the amine oxide compound is included as the mobility control fluid to have advantages of a non-ionic surfactant and an ionic surfactant, thereby securing solvency to the carbon dioxide, foam formation and foam retention force at the same time, such that the mobility control fluid may be well diffused in the well bore and stable foam and lamella may be retained to increase viscosity, thereby improving mobility.

What is claimed is:

1. A mobility control fluid composition comprising an amine oxide compound.

2. The mobility control fluid composition of claim 1, wherein the amine oxide compound is represented by the following Chemical Formula 1 or 2, or mixtures thereof: 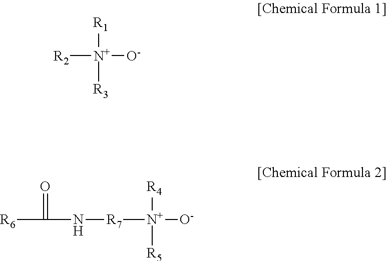
in Chemical Formulas and R₁, R₂, R₃, R₄, R₅ or R₆ is each independently a linear or branched C1-C30 alkyl group, or a C3-C7 cycloalkyl group, R₇ is a C1-C7 alkylene group or a C3-C7 cycloalkylene group, and —CH₂— which is a carbon atom of the alkyl group and the cycloalkyl group of R₁ R₆ and the alkylene group and the cycloalkylene group of R₇ may be substituted with —NR′— or —O—, and R′ may be hydrogen, or a linear or branched C1-C30 alkyl group.

3. The mobility control fluid composition of claim 2, wherein R₁ or R₆ is each independently a linear or branched C7-C30 alkyl group, and R₂, R₃, R₄, or R₅ is each independently a linear or branched C1-C3 alkyl group.

4. The mobility control fluid composition of claim 3, wherein the amine oxide compound is one or more selected from the following structural compounds:

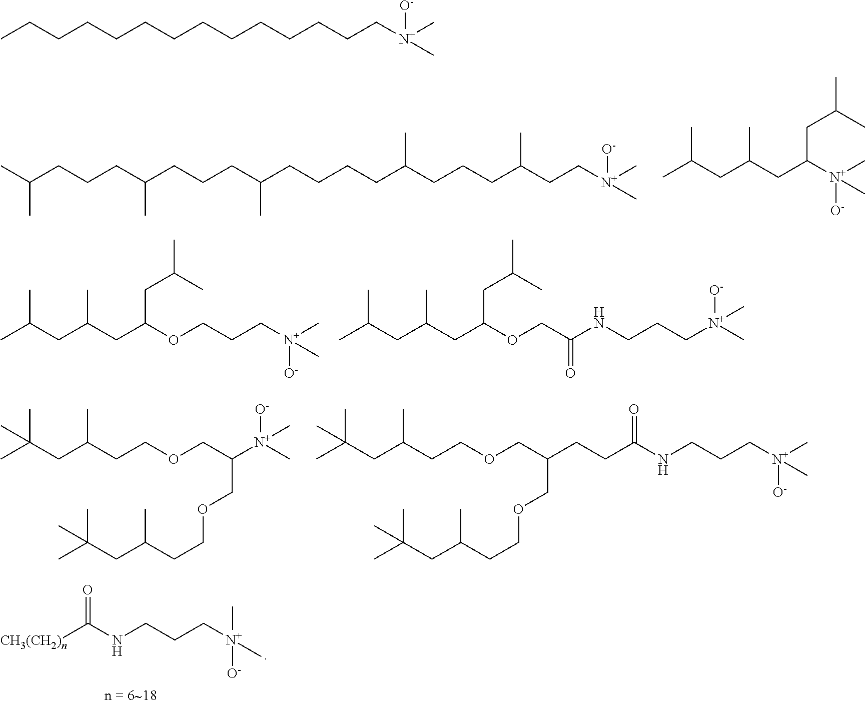

5. The mobility control fluid composition of claim 2, wherein the amine oxide compound is included in an amount of 0.01 to 10 wt %.

6. The mobility control fluid composition of claim 2, wherein the amine oxide compound is included in an amount of 0.05 to 2 wt %.

7. An enhanced oil recovery method from an oilfield, comprising:
injecting a driving fluid, and
injecting a mobility control fluid composition including an amine oxide compound.

8. The enhanced oil recovery method of claim 7, wherein the amine oxide compound is represented by the following Chemical Formula 1 or 2, or mixtures thereof: 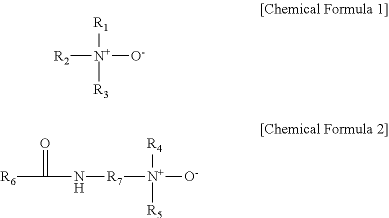
in Chemical Formulas 1 and 2, R₁, R₂, R₃, R₄, R₅ or R₆ is each independently a. linear or branched C1-C30 alkyl group, or a C3-C7 cycloalkyl group, R₇ is a C1-C7 alkylene group or a C3-C7 cycloalkylene group, and —CH₂— which is a carbon atom of the alkyl group and the cycloalkyl group of R₁ to R₆ and the alkylene group and the cycloalkylene group of R₇ may be substituted with —NR′— or —O—, and R′ may be hydrogen, or a linear or branched C1-C30 alkyl group.

9. The enhanced oil recovery method of claim 8, wherein the amine oxide compound is one or more selected from the following structural compounds:

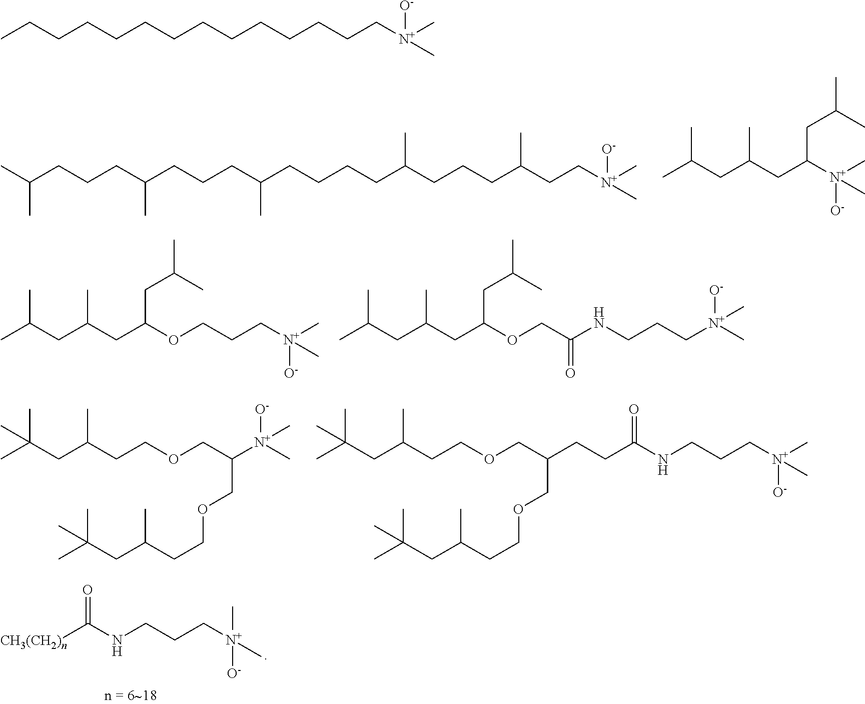

10. The enhanced oil recovery method of claim 9, wherein the amine oxide compound is included in an amount of 0.01 to 10 wt %.

11. The enhanced oil recovery method of claim 9, wherein the amine oxide compound is included in an amount of 0.05 to 2 wt %.

12. The enhanced oil recovery method of claim 9, wherein the oilfield into which the driving fluid and the mobility control fluid composition are injected has a pH of 3 to 10, a temperature of 10 to 70° C., and a salt in an amount of 5 to 25 % or less.

13. The enhanced oil recovery method of claim 9, wherein the injecting of the driving fluid is stopped when the driving fluid is swept into a producing well bore.
